(19) United States
(12) Patent Application Publication
(10) Pub. No.: US 2001/0047280 A1
(43) Pub. Date: Nov. 29, 2001

(54) Method and apparatus for facilitating relocation

(76) Inventors: Sam Alexander, Lebanon, NH (US); George Spitzer, Etna, NH (US); Ben T. Sommers, Golden, CO (US); David J. Paul, Fremont, CA (US); Michael Pearson, Norwich, VT (US)

Correspondence Address: LEWIS & ROST, 5575 DTC PARKWAY, SUITE 230, GREENWOOD VILLAGE, CO, 80111-3016, US

(21) Appl. No.: 09/864,438

(22) Filed: May 24, 2001

Related U.S. Application Data
(60) Provisional application No. 60/206,940, filed on May 25, 2000.

(51) Int. Cl. G06F 17/60

(52) U.S. Cl. 705/1; 705/30

(57) ABSTRACT

A method for facilitating relocation includes receiving user preferences, calculating from service provider quoted and actual performance data the probability of a successful relocation, and selecting and recommending service providers that will provide a relocation at the lowest cost with the highest probability of success. Apparatus for facilitating relocations includes input devices for receiving user preferences, output devices for sending recommendations and reports, a data storage device with a database for storing user preferences, service provider quoted performance data and service provider actual performance data, and a processor, connected to the input devices, output devices and data storage device, that performs the method for facilitating relocation.

This application claims the benefit under 35 U.S.C. §119(e) of the U.S. provisional patent application No. 60/206,940 filed May 25, 2000.

### TECHNICAL FIELD

The present invention relates to relocation services and more particularly to a method and apparatus for facilitating pre-relocation, relocation, and post-relocation for the least cost with the highest probability of success.

### BACKGROUND ART

There were approximately 6.1 million homes sold in the United States in 1999, resulting in about 3.6 million moves or personal relocations from one location to another. Each relocation is a complex process requiring co-ordination of service providers in several industries such as personal transportation, moving of personal property, home selling, home buying, storage, and temporary living accommodations.

About 1.8 million of the 3.6 million relocations were company relocation moves or transfers. Less than one third or about 500,000 of these transfers were fully paid and coordinated for the employee by the employer. The employer partially paid or did not pay for the balance of 1.3 million company employee relocation moves and the balance of non-company relocation moves, 1.8 million, had no specialized coordination or paid support.

Prior known relocation systems and methods are suitable for company paid employee relocation. U.S. Pat. No. 4,700,297 to Hagel, Sr. et al. discloses a system that tracks company relocation expenses. U.S. Pat. No. 6,049,781 to Forrest et al. discloses a relocation system and method for a company relocation program. The system of Forrest et al. includes a storage device with a database having a plurality of tables, and a processor operable to process a relocation request and to access and update the tables. The tables include a tracking table with service provider performance data and ratings for use by a relocation coordinator in selecting service providers. The transferee cannot directly access the system, the system is dependent on corporate databases and provides only services authorized by the company, making the system only suitable for company relocation programs.

Prior known relocation methods and systems lack the flexibility to provide tailored coordination of the relocation of an individual consumer. Known systems overwhelm many individuals with the information and choices offered. Also, prior known systems do not offer archival record recall to consumers with multiple move histories. Systems with a user-friendly format for the person being relocated, whether a non-company employed individual or company transferee, do not exist. Prior known relocation methods and systems arbitrarily and subjectively select service providers and do not provide a method for objectively selecting service providers to provide a lower cost move with a higher probability of success for a particular individual user.

### DISCLOSURE OF THE INVENTION

A method of facilitating relocation is disclosed including the steps of collecting user data for a relocation, matching the user data to service provider data, calculating a probability of a successful relocation, providing service provider recommendations and the probability of a successful relocation to the user, scheduling tasks for the relocation, confirming service completion for the relocation, collecting service provider performance data, rewarding the user for using the system and providing the service provider data. The probability of a successful move is the product of the probability of writing a contract and the probability of executing the contract. Apparatus for facilitating relocation includes a processor, a data storage device, and input and output devices. The data storage device has a database with the user data and the service provider performance data. The processor is operable to access and update the database, to receive user data and service provider performance data from the input devices, to coordinate a relocation, to calculate a probability of success of the relocation, and output to the output devices reports to the user that include recommended service providers and the probability of success of the relocation.

### BRIEF DESCRIPTION OF THE DRAWINGS

Details of this invention are described in connection with the accompanying drawings that bear similar reference numerals in which:

FIG. 1 is a schematic block diagram of a method embodying features of the present invention.

FIG. 2 is a summary graphical view of the relationship of cost to timeliness for a plurality of service providers for the method of FIG. 1.

FIG. 3 is a schematic block diagram of apparatus embodying features of the present invention.

FIG. 4 is a schematic block diagram of the software modules of the apparatus of FIG. 4.

FIG. 5 is a representative view of a screen display for user data input for the apparatus of FIG. 4.

FIG. 6 is a representative view of a screen display for a recommendation report for the apparatus of FIG. 4.

### DETAILED DESCRIPTION OF THE INVENTION

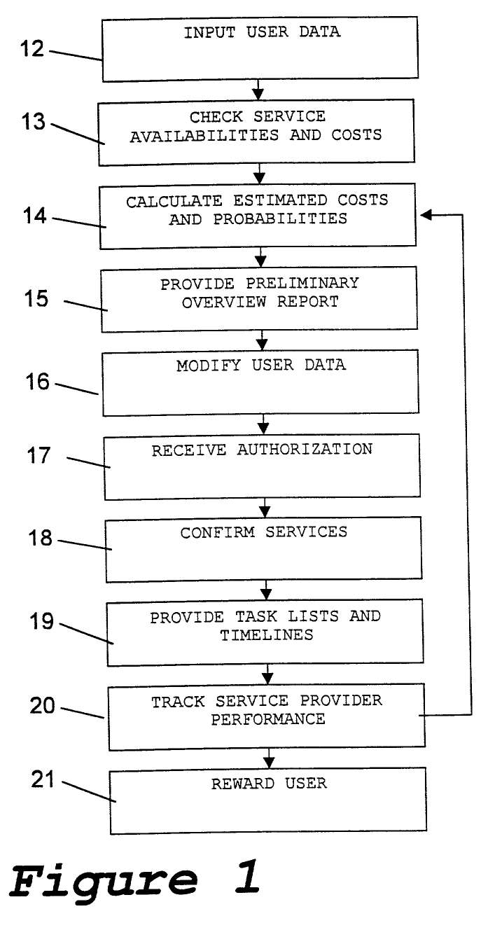

Referring now to FIG. 1, a method embodying features of the present invention is shown including the steps of input of user data 12, check of service availabilities and costs 13, calculation of estimated costs and probabilities of success for each selected service 14, provision of a preliminary overview report to the user of estimated costs, probabilities of success and service provider initial recommendations 15, modification of user data in response to the preliminary overview report 16, user authorization of each service and service provider 17, confirmation that each service provider has scheduled the selected service 18, provision to the user of task lists and timelines 19, tracking of service provider actual performance 20 and update of rewards program 21.

The step of input of user data 12 includes identifying the user, providing to the user a list of available services, receiving the selection of one or more services chosen from the list by the user, and collecting user data and preferences. The user may be a company relocation coordinator acting for an employee, an employee being transferred, a relocation coordinator of a relocation company acting for an individual, or an individual being transferred or wanting to move.

The list of available services may include, but is not limited to, home selling assistance, home buying assistance, home mortgage assistance, personal property shipping assistance, temporary living assistance, tax preparation assistance, career counseling assistance, and hookup and disconnect services.

The step of collecting user data and preferences includes providing a plurality of queries to the user, receiving answers to the queries from the user and storing the user data in a relocation database. General user data includes the name, current address and current phone number of the user. General user data also includes the names and ages of the other family members, the number and types of pets, and any special needs. Also, general user data includes contact information such as a work number, a fax number and an email address. The destination city and state, the start date at the destination, and the new office address, phone number, fax number and email address are included in the general user data.

For home selling assistance the user data includes details of the home to be sold, including, but not limited to, a description of the property, mortgage information, any listing agent information and marketing history. The description of the property includes property size, location, setting and legal description, structure size, type and construction type, number and types of rooms, utilities types, and any special features. The mortgage information includes, for each mortgage, the lending institution name, customer service phone number, fax number and email address, loan number, original balance and current balance. Listing agent information includes the company name, address, phone number and fax number, the agent's name, phone numbers and email address, the list date, the expiration date, any listing agent incentive and any selling agent incentive. The marketing history includes the original and current asking prices, date of the last reduction, buyer incentives, the date, amount and result of any offers, and the number of showings in the last month and the previous month.

For home buying assistance the user data includes preferences of the desired home such as a desired price range and monthly payment, and whether the user is pre-qualified. The user data for home buying assistance includes the desired lot size, location and setting, such as urban, suburban or rural. Home buying assistance user data also includes the desired home size, type, style and construction type, number and types of rooms, utilities types, special requirements. Home types can include single family, condominium, townhouse, mobile home, co-op or other. Home styles could include two-story, ranch, split level or others. Home buying assistance user data also includes any special needs or preferences. If the user is already working with a destination home buying agent, the user data includes the name, company, address, phone number, fax number, and email address of the agent as well as the date of referral, date of contact, date of any purchase contract or date of closing on a new home.

If the user has already engaged a lender for a new home, the user data for new mortgage assistance includes the mortgage company name, address, phone number and fax number, and a contact name and email address at the mortgage company. New mortgage assistance user data also includes the date of referral to the mortgage company, the date of contact by the mortgage company, the date of loan application, the date of pre-qualification, the pre-qualification amount, the interest rate, the date of loan approval, the approval amount, and any special remarks.

User data for personal property shipping includes the desired departure and delivery dates, and if the user has already contacted a moving company, the user data includes a moving company name, a contact name, the moving company address, phone number, fax number and email address, a contact date, an estimate date, and an estimate amount. User data for temporary living assistance includes any temporary company name with a contact name, an address, a phone number, a fax number and an email address. Temporary living assistance data also includes the preferred type of accommodation and projected time needed.

User data for career counseling assistance includes any career counseling company name with a contact name, an address, a phone number, a fax number and an email address. Career counseling user data also includes the career counseling services desired, such as general counseling, resume writing and interview skills. User data for tax preparation assistance includes any tax preparation company name with a specialist's name, an address, a phone number, a fax number and an email address. For each selected service, user data will include qualification of the relative importance of the user preferences such as cost, timeliness and quality.

Hookup and disconnect services may include telephones, cell phones, utilities, pager, long-distance telephone carrier, cable TV, Internet service provider, newspapers, magazines, mail for friends and vendors, and new banking accounts. For each service hookup or disconnect service user data includes the service provider name, the customer service phone number, the account number (or phone number), the service provider address and date desired for connection or disconnection.

The step of checking service availabilities and costs 13 includes data staging, services correlation, notification to service providers of potential use of service and receipt of service availability and costs from the service providers. Data staging includes formatting the user data and storing the user data in the appropriate files or tables in a relocation database.

Services correlation includes determination of available options for each selected service, selection of potential service providers, initial selection of specific service products and initial estimation of costs for each service. Available options, by way of example, but not limited to, for home selling assistance may include user self sale assistance or full realty service, or for personal property shipping may include the options of user self move with van rental assistance, user pack, mover load and drive, or mover pack, load and drive.

Prior to or at the time of the services correlation, service provider data is gathered and stored in the relocation database. Service provider data for each service provider includes contact and identification data such as name, company name, address, phone number, fax number and email address. Service provider data will also include service provider quoted cost and performance data and actual service provider cost and performance data collected at the step of tracking service provider performance 20, as will be described hereinafter. Service provider data is matched to each selected service, and the service providers with the best performance for each selected service are selected.

The relocation database includes models or algorithms of the relations between specific service products and factors or variables, and the relations between the factors. Many of the algorithms model a linear relationship between the products and factors. Such an algorithm is expressed as y=mx+b, where y is the product quantity, m is a first constant and represents the slope, x is the independent variable or factor and b is the second constant.

By way of example, and not as a limitation, the following relationships are modeled as linear. The available mortgage size is inversely proportional to the credit rating and is inversely proportional to the interest rate, with each first constant m being negative. The available mortgage size is directly proportional to each of the user's income, the downpayment amount, and the user's assets, with each first constant m being positive. The number of mortgage products available is directly proportional to each of the user's income and the downpayment amount and inversely proportional to the number of late payments. The credit rating is also inversely proportional to the number of late payments. The mortgage processing time is inversely proportional to the downpayment percentage. The time to move personal property and the dollar amount of claims associated with moving personal property are each directly proportional to the level of user involvement, each increasing with increased user involvement.

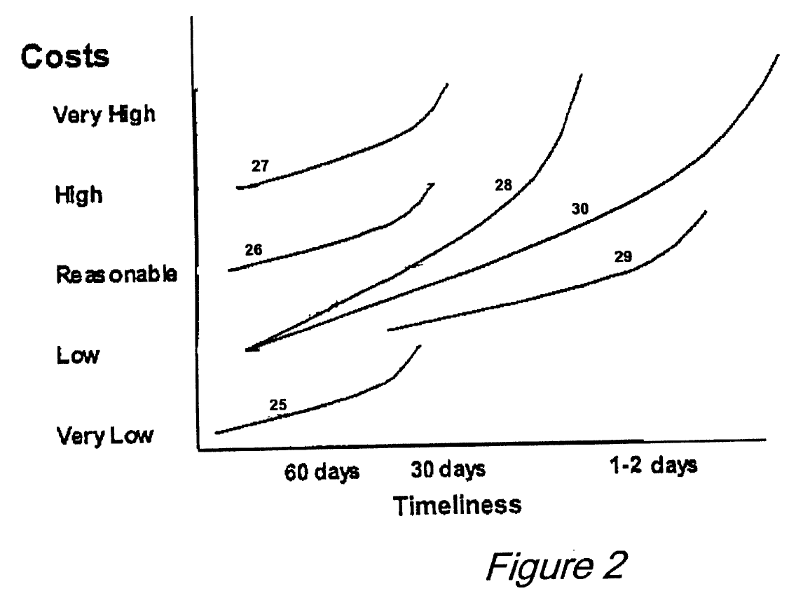

The relationship between other factors is non-linear. Service provider quoted performance curves are extrapolated from service provider quotes and specifications. Data points for service provider actual performance are stored in the relocation data base and curves are extrapolated, generally by regression, from the data points for each service provider. By way of example, and not as a limitation, FIG. 2 shows curves for six service providers for cost as a function of the time to create a move, with all other factors held constant. The x axis, representing timeliness, decreases to the right, and the y axis represents cost and increases going up. The curve for each provider slopes upward to the right, indicating that the cost to provide the service increases as the time to provide the service decreases. The slope of each curve increases as the curve approaches the minimum time that the service is provided by that service provider, indicating that the rate of cost increase is high near the minimum time for each service provider.

The curve for the first provider 25 extends from a long time and very low cost to a medium time and a low cost. The curve for the second provider 26 extends from a long time and reasonable cost to a medium time and a high cost. The curve for the third provider 27 extends from a long time and high cost to a medium time and a very high cost. The curve for the fourth provider 28 extends from a long time and low cost to a medium-short time and a very high cost. The curve for the fifth provider 29 extends from a long time and low cost to a short time and a high cost. The curve for the sixth provider 30 extends from a long time and low cost to a very short time and a very high cost.

The relocation database includes a plurality of linear and non-linear service provider curves defining the relationships between cost, quality, timeliness, service availability and service product availability for each service provider. The relocation database contains service provider curves for each relationship for service provider quoted performance and for service provider actual performance. The relocation database also includes operating characteristic curves defining cost, quality and timeliness as a function of season, geography, calendar dates, geographic and special limitations.

The combination of quoted performance curves for a service provider forms a finite n-dimensional quoted performance surface. Similarly, the user data and preferences are modeled as a plurality of curves for the same factors to form a finite n-dimensional user surface. The initial selection of specific service products and service providers includes matching the user surface to the service provider quoted performance surfaces and the operating characteristic curves to select the service products and service providers that best meet the user preferences at the lowest cost and highest quality to create the lowest cost move with the highest quality.

In the preferred embodiment, selected factors, such as cost and quality, are given greater importance or weight in the matching process. The relative importance of each factor is set by rules that are stored in the relocation database and continually updated based on the data collected at the step of tracking of service provider actual performance 20. Alternately, all factors could be given equal weight or other factors could be given greater importance.

The initial estimation of the costs is generated from the user data combined with service provider cost data. By way of example, and not as a limitation, the quantity or weight of the personal property that will be shipped can be projected from the current home size in the user data, and the cost to ship this quantity or weight from the originating address in the user data to the destination in the user data is estimated from service provider cost data.

After services correlation, service providers are notified of potential use of service and queried for service availabilities and costs. In the preferred embodiment of the present invention, in order to protect user privacy, the user must authorize each service provider for notification prior to notification of that service provider. The service providers respond with service availability and cost quotes.

The calculation of estimated costs and probabilities of success for each selected service 14 includes calculating costs from the service availability and cost quotes received from the service providers and calculating probabilities of success based on service provider data in the relocation data base. The probability of success P_{S} is calculated as P_{S}=P_{C}×P_{E}, where P_{C} is the probability of creating a successful contract and P_{E} is the probability of successful execution of the contract. The probability P_{C} is the probability that the quoted performance surface of at least one service provider matches the user preferences in the user data. The probability P_{E} is the probability that the service provider will perform at the quoted level, and is a function of the service provider quoted performance compared to the service provider actual performance data.

A preliminary overview report including the estimated costs, probabilities of success and service provider initial recommendations is provided to the user. The user modifies the user data in response to the preliminary overview report 16. The estimated costs, probabilities of success and service provider initial recommendations are recalculated in response to the modified user data and a new overview report is generated.

When the user is satisfied with the estimated costs, probabilities of success and service provider initial recommendations, the user selects and authorizes service products and service providers. The relocation system receives the authorizations from the user and sends the authorizations to the selected service providers. In the preferred embodiment of the present invention, with the exception of hookup and disconnect services, the service provider contacts the user, and the user directly contracts with the service provider. The relocation system processes the hookup and disconnect services. Alternatively, the relocation system could contract each service provider.

The relocation system confirms that the user has formed a contract with each selected service provider and that each service provider has scheduled the selected service 18. The relocation system provides the user with task lists and timelines 19. The user completes the tasks from the task lists and, with the services provided by the service providers, completes the relocation.

The step of tracking of service provider actual performance 20 includes, after each service provided by a service provider is complete, the relocation system collecting new actual performance data for that service provider and storing the new actual performance data in the relocation data base. The actual performance data is collected from the service provider and from the user. The collected new actual performance data is combined with previously stored actual performance for the service provider in the relocation database to refine the actual performance surface of the service provider and to reduce dispersion.

For listing agents, the relocation system collects data on geographical area or real estate expertise, responsiveness to the initial contact with the consumer, completeness of the Broker Price Opinion, marketing strategies, the follow up process, timely and regular communications, reports generated, consumer income comfort level, average price of property listed, average length of time the property is on the market, variance between sale price vs. broker price opinion, and overall satisfaction rating by consumers.

For real estate sales providers, the relocation system collects data on responsiveness to the initial contact with the consumer, rapport building skills, completeness of area information packets, geographical real estate area covered, average price range of the consumer, average length of time between initial contact and sales contract, variance between listed price and contract purchase price, contingency resolution skills, and percentage of properties that fail to close.

For appraisal providers, the relocation system collects data on the seller obtaining an appraisal for sale of a home, responsiveness to initial contact, rapport building skills, completeness and thoroughness of the appraisal report, average variance between appraised value and sales price, average number of days the property is on the market, and overall satisfaction rating by consumer. Data is collected for van line performance for responsiveness to initial contact, rapport building skills, completeness and thoroughness of presenting the coordination of the moving process, completeness of the estimate, variance between the estimate and final costs, driver performance, on time delivery of service for packing and loading date, departure date and delivery date, average number of damage claims, average amount of the damage claims, average length of time to settle claims, variance between claim and settlement, and overall satisfaction rating. Mortgage performance data is collected for responsiveness to initial contact, rapport building skills, clear explanation of the process, and overall satisfaction rating.

Update of the rewards program 21 includes providing rewards to the user. The rewards are contingent on the user using the system and providing service performance data for the service providers for the provided services for the relocation. The user data is archived for update and use in future relocations.

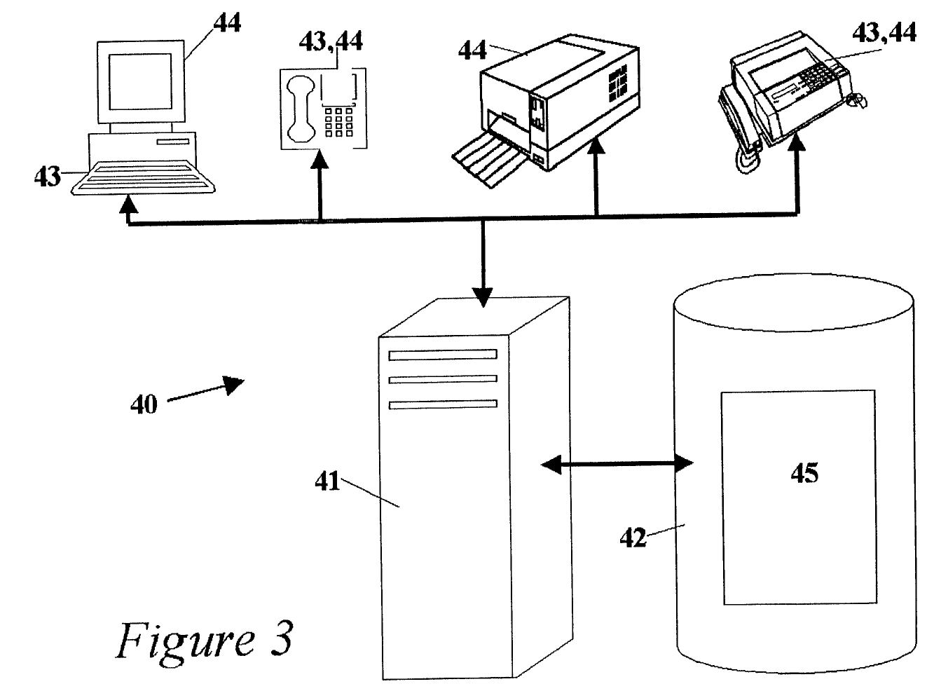

Referring to FIG. 3, relocation apparatus 40 embodying features of the present invention is shown, including a processor 41, a data storage device 42, and input and output devices 43 and 44. The relocation apparatus may include more than one processor 41 and more than one data storage device 42 within the scope of the invention. The processor 41 is connected to the data storage device 42 directly through a bus or indirectly through a Local Area Network (LAN) or a Wide Area Network (WAN). The data storage device 42 stores the user data, service provider data, and operating characteristic curves, as described above, preferably in one or more databases 45. The processor 41 is operable to access and update data in the databases 45 and to perform the method of the present invention, as described above, through execution of a plurality of software modules described hereinafter.

Input devices 43 may include any known type of input device including, but not limited to, keyboards, keypads, pointing devices such as a mouse or trackball, facsimile machines, and telephones and microphones linked through voice recognition software. Output devices 44 may include any known type of output device including, but not limited to, graphical displays and character displays in the form of Cathode Ray Tubes (CRT) and Liquid Crystal Displays (LCD), facsimile machines, printers, and telephones and speakers linked through voice generation software. The input devices and output devices 43 and 44 are connected directly to the processor 41 or indirectly to the processor 41 through a LAN, a WAN, an intranet, an extranet or the Internet.

In the preferred embodiment of the present invention, a user accesses the relocation system through the Internet. The relocation system provides a Graphical User Interface (GUI) for a graphical display for user data input and for relocation system output to the user. The relocation system preferably communicates with service providers through email and the Internet, but may also communicate with service providers by fax or through a human operator of the relocation system.

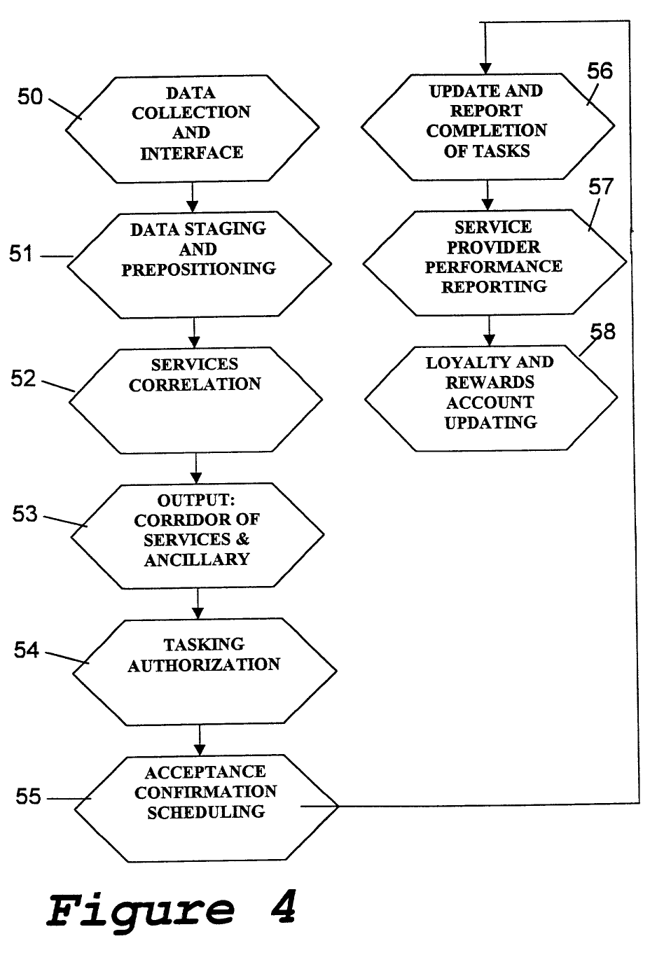

The software executed by the processor 41 to perform the method of the present invention, as shown in FIG. 4, includes nine modules. The first module 50 is the data collection module and corresponds to the step of input of user data 12. The first module 50 includes a GUI that presents queries to the user and collects user responses. A text box, radio buttons, a drop down menu or other response means is provided for each query depending on the type of query. For example, if appropriate responses for selection of each service are “yes” or “default”, a radio button is provided for each of the two choices, whereas text is the appropriate response for name, address and phone number queries and text boxes are provided for name, address and phone number responses.

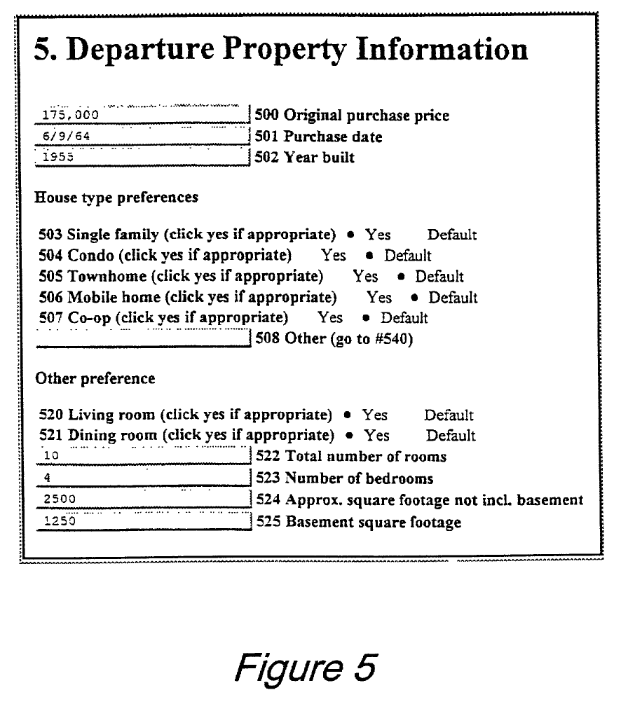

A sample query screen is shown in FIG. 5. Text boxes are provided for responses for queries for “Original purchase price”, “Purchase date”, “Year built”, house type “Other”, “Total number of rooms”, “Number of bedrooms”, “Approx. square footage not incl. basement”, and “Basement square footage”. Radio buttons with the choices of “Yes” or “Default” are provided under house types for “Single family”, “Condo”, “Townhouse”, “Mobile home” and “Co-op”, and under other for “Living room” and “Dining room”. Alternately, the selection of house type could be from a drop down menu or a plurality of check boxes.

Referring again to FIG. 4, the second module 51 formats user data collected by the first module 50 and prepares the user data for use in subsequent operations. The third module 52 provides services correlation, as described above, and includes identification of specific services, types, durations, cost estimates, geographical locations, tailored content, and options that most cost effectively meet the needs expressed by the user in the first module 50.

The fourth module 53 notifies service providers of the potential use of each service provider's service, checks costs and availability of services with the service providers, checks for other conditions, such as adverse weather, that could effect the relocation, and generates a preliminary overview report. Notification of each service provider must be authorized by the user, to protect the privacy of the user. The fourth module 53 includes the computation of the least cost critical path with the highest probability of success, and the preliminary output report with initial service provider and service product recommendations with the probabilities of success for each service provider and each service product.

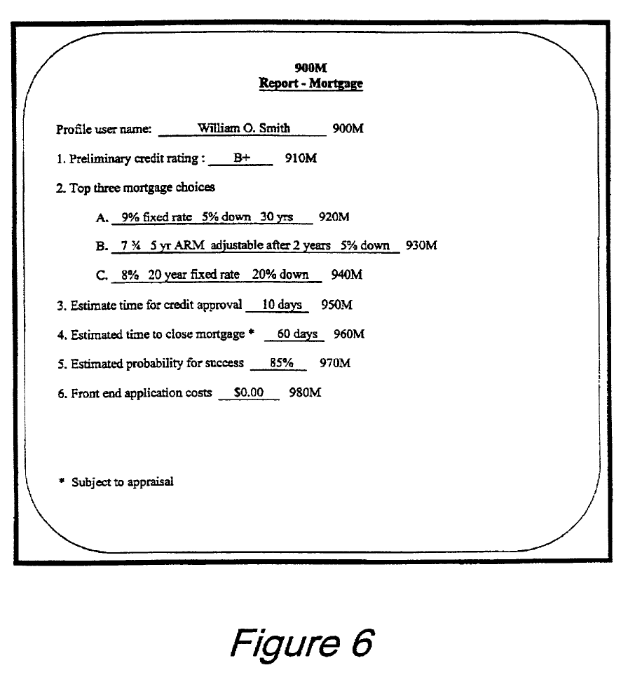

FIG. 6 shows a sample recommendation screen. The screen is a mortgage report and includes the user name and the preliminary credit rating. The top three mortgage products available for the user are shown, including the interest rate and type, the required down payment percent and the term for each product. The estimated time for credit approval, estimated time to close the mortgage, the estimated probability of success, and the front end application costs are also shown.

Referring again to FIG. 4, the fifth module 54 receives user modifications, user selections from the recommended service providers and service products, and user authorization for specific services. The sixth module 55 transmits service authorizations to the service providers, checks for completion of payment arrangements by the user to the service providers, verifies that each authorized service is scheduled and confirmed with the user.

The seventh module 56 collects task completion data including reasons that a service was not completed as specified and authorized, and notifies the user on progress, status, and updated estimated completion dates. The eighth module 57 collects service provider performance data and updates the service provider performance indices. The ninth module 58 updates the user loyalty, rewards, and account information, provides to the user additional information about program referrals, and permits the user to check on the status of their individual accounts

Although the present invention has been described with a certain degree of particularity, it is understood that the present disclosure has been made by way of example and that changes in details of structure may be made without departing from the spirit thereof.

What is claimed is:

1. A method for facilitating a relocation comprising the steps of:
providing a relocation database having stored performance data for a plurality of relocation service providers, said stored performance data including cost and quality,
receiving user data from a user including at least one selected service and user preferences for each said selected service, and
providing at least one service provider initial recommendation to said user for each said selected service, each said initial recommendation designating a service provider and including an estimated cost for said service provider and an estimated probability of said service provider successfully fulfilling said user preferences.

2. The method of claim 1 further comprising the steps of:
receiving modified user preferences in response to said initial recommendation from said user, and
providing at least one service provider final recommendation to said user for each said selected service, each said final recommendation designating a service provider and including an estimated cost for said service provider and an estimated probability of said service provider successfully fulfilling said user preferences.

3. The method of claim 2 further comprising the steps of:
receiving service provider new performance data from said user after completion of each said selected service,
combining said new performance data with said stored performance data to refine said stored performance data and to reduce dispersion of said stored performance data.

4. The method of claim 3 further comprising the step of providing rewards to said user in response to receiving said new performance data.

5. The method of claim 1 wherein said estimated probability is the product of a probability of writing a contract with one said service provider and a probability of executing said contract.

6. The method of claim 5 wherein:
said stored performance data includes quoted performance data and actual performance data for each said service provider,
said probability of writing a contract for a selected service is the probability that said quoted performance data for at least one said service provider fulfills each of said user preferences for said selected service, and
said probability of executing said contract is the probability that a said service provider having quoted performance data that fulfills each of said user preferences for said selected service will fulfill each of said user preferences for said selected service.

7. The method of claim 1 wherein said selected service is selected from a group of services including home selling assistance, home buying assistance, home mortgage assistance, personal property shipping assistance, temporary living assistance, and hookup and disconnect services.

8. The method of claim 1 wherein said step of providing at least one service provider initial recommendation includes the substeps of:
comparing said user preferences to said stored performance data for each service provider for each said selected service, and
selecting at least one said service provider with stored performance data that most closely fulfills said user preferences at the lowest said cost and highest said quality for each said selected service.

9. A method for facilitating a relocation comprising the steps of:
providing a relocation database having stored performance data for a plurality of relocation service providers, said stored performance data including quoted performance data and actual performance data for each said service provider
receiving user data from a user including at least one selected service and user preferences for each said selected service, said selected service being selected from a group of services including home selling assistance, home buying assistance, home mortgage assistance, personal property shipping assistance, temporary living assistance, and hookup and disconnect services,
providing at least one service provider initial recommendation to said user for each said selected service including comparing said user preferences to said stored performance data for each service provider for each said selected service and selecting as a selected service provider at least one said service provider with stored performance data that most closely fulfills said user preferences at the lowest said cost and highest said quality for each said selected service, each said initial recommendation designating said selected service provider and including an estimated cost for said selected service provider and an estimated probability of said selected service provider successfully fulfilling said user preferences, said estimated probability being the product of a probability of writing a contract with one said service provider and a probability of executing said contract, said probability of writing a contract for a selected service being the probability that said quoted performance data for at least one said service provider fulfills each of said user preferences for said selected service, said probability of executing said contract being the probability that a said service provider having quoted performance data that fulfills each of said user preferences for said selected service will fulfill each of said user preferences for said selected service,
receiving modified user preferences in response to said initial recommendation from said user, and
providing at least one service provider final recommendation to said user for each said selected service, each said final recommendation designating a service provider and including an estimated cost for said service provider and an estimated probability of said service provider successfully fulfilling said user preferences,
receiving service provider new performance data from said user after completion of each said selected service,
combining said new performance data with said stored performance data to refine said stored performance data and to reduce dispersion of said stored performance data, and
providing rewards to said user in response to receiving said new performance data.

10. Apparatus for facilitating relocation comprising:
a data storage device with a database having stored performance data for a plurality of relocation service providers,
an input device,
an output device, and
a processor connected to said data storage device, said input device and said output device, and operable to receive at least one selected service and user preferences for said selected service from said input device, said processor being operable to access said stored performance data to match said stored performance data to said user preferences and calculate a service provider recommendation therefrom, and said processor being operable to calculate a probability of success of provision of said selected service and to transmit said service provider recommendation and said probability to said output device.

11. The apparatus as set forth in claim 10 wherein said stored performance data includes quoted performance data and actual performance data for said service providers.

12. The apparatus as set forth in claim 11 wherein said processor is operable to calculate said probability of success as the product of a probability of writing a contract and a probability of executing said contract.

13. The apparatus as set forth in claim 12 wherein:
said probability of writing a contract is the probability that said quoted performance data for at least one said service provider fulfills each of said user preferences for said selected service, and
said probability of executing said contract is the probability that a said service provider having quoted performance data that fulfills each of said user preferences for said selected service will fulfill each of said user preferences for said selected service.

14. The apparatus as set forth in claim 11 wherein said processor is operable to receive new performance data for said service providers from said input device and to combine said new performance data with said actual performance data to refine said actual performance data and to reduce dispersion.

15. The apparatus as set forth in claim 11 wherein said processor is operable to match said quoted performance data to said user preferences and select, as said service provider recommendation, at least one said service provider with quoted performance data that most closely fulfills said user preferences at the lowest cost and highest quality for each said selected service.

16. Apparatus for facilitating relocation comprising:
a data storage device with a database having stored performance data for a plurality of relocation service providers, said stored performance data including quoted performance data and actual performance data for said service providers,
an input device,
an output device, and
a processor connected to said data storage device, said input device and said output device, and operable to receive at least one selected service and user preferences for said selected service from said input device, said processor being operable to access said stored performance data to match said stored performance data to said user preferences and calculate a service provider recommendation therefrom,
said processor being operable to match said quoted performance data to said user preferences and to select, as said service provider recommendation, at least one said service provider with quoted performance data that most closely fulfills said user preferences at the lowest cost and highest quality for each said selected service,
said processor being operable to calculate a probability of success of provision of said selected service with said probability of success being the product of a probability of writing a contract and a probability of executing said contract,
said probability of writing a contract being the probability that said quoted performance data for at least one said service provider fulfills each of said user preferences for said selected service, and
said probability of executing said contract being the probability that a said service provider having quoted performance data that fulfills each of said user preferences for said selected service will fulfill each of said user preferences for said selected service,
said processor being operable to transmit said service provider recommendation and said probability to said output device, and
said processor being operable to receive new performance data for said service providers from said input device and to combine said new performance data with said actual performance data to refine said actual performance data and to reduce dispersion.
